(19) United States
(12) Patent Application Publication
(10) Pub. No.: US 2005/0021551 A1
(43) Pub. Date: Jan. 27, 2005

(54) Current mailing address identification and verification

(75) Inventors: Steven W. Silva, Marblehead, MA (US); Jon Larotella, Boxford, MA (US)

Correspondence Address: MAINE & ASMUS, 100 MAIN STREET, P O BOX 3445, NASHUA, NH, 03061-3445, US

(73) Assignee: LOCATEPLUS CORPORATION, Beverly, MA (US)

(21) Appl. No.: 10/857,056

(22) Filed: May 28, 2004

Related U.S. Application Data
(60) Provisional application No. 60/474,122, filed on May 29, 2003.

(51) Int. Cl. G06F 7/00; G06F 17/00

(52) U.S. Cl. 707/102

(57) ABSTRACT

Techniques for identifying a target individual's or entity's current address are disclosed. An initial query/search on the target is performed to identify previously reported addresses of that target. This initial query specifies information known about the target (e.g., target's name, along with city and/or state in which the target is to believed to reside). The initial query attempts to match the specified target information to existing entries in a database storing previously reported addresses. Any target matches resulting from this initial search are presented to the user. Target matches selected for verification contain previously reported addresses associated with the target match. Each of these previously reported addresses are then queried into a database storing high-confidence records (e.g., public utility records). If a previously reported address is verified as being the current mailing address, then that address (or its corrected version) is reported to the user.

### RELATED APPLICATIONS

This application claims the benefit of U.S. Provisional Application No. 60/474,122, filed 29 May 2003, which is herein incorporated in its entirety by reference.

### FIELD OF THE INVENTION

The invention relates to contact information, and more particularly, to a techniques for identifying and verifying with high-confidence a current mailing address for individuals and entities.

### BACKGROUND OF THE INVENTION

Despite attempts at maintaining current contact information when a person or business moves, it is a common result that old contact information remains of record in various locations. Contact information of an individual or business typically includes the physical location and postal address, including the street number or post office box, street name, city and state. Other contact information may include, for example, one or more telephone numbers, facsimile numbers, and email addresses. Personal information, such as a social security number and date of birth may also be associated with the contact information that is maintained.

After a household move, a person generally tries to notify as many service providers and vendors, as well as family, relatives and friends, but there are always a number of organizations and individuals that are inadvertently not notified. A business or other entity that has moved is likely to have a similar problem, where not all service providers, customers, etc. are notified of the new contact information. Also, there is a chance that the recipients of the contact change information may lose or improperly record the changes.

In addition to these inadvertent instances resulting in stale contact information, there are also those instances where individuals simply do not wish to be located. Furthermore, people may get married and adopt a married name, or legally change their name for one reason or another. In addition, the manner in which a contact name is presented can also change. Shortened first names, nick-names, middle initials or lack thereof, and the addition of titles, such as M.D., can all serve to make the address tracking process more complicated.

There are a number of conventional services that attempt to track the current addresses of individuals and businesses. These systems generally search or otherwise use telephone directories (e.g., online white and yellow pages) or postal service address records (e.g., United States Postal Service database) as the basis of their information. Various known techniques for efficiently searching and retrieving information from a structured database are employed. While such databases can store large amounts of searchable data, the accuracy of that data is essentially untested and may be inaccurate (e.g., due to insufficient updating, loss of data, or data entry error).

Furthermore, while the United States Postal Service (USPS) validates addresses as “accurate” (meaning that the target address on a letter or parcel is confirmed to be an actual address within the existing delivery system serviced by the USPS), there is still no verification that the intended recipient marked on the letter or parcel actually resides at that target address. Thus, the existing address matching database methods fail to verify with high-confidence that a particular individual or business can be contacted at a particular address.

There are also numerous search engines that index millions of Web pages based on keywords, metatags, and other search criteria that return targeted search results. These search results, however, are complete only to the extent afforded by the search mechanics, and relevant sites may very well be excluded from the search results. Moreover, the search results returned are merely lists of Web pages that satisfy the search criteria provided to the search engine.

What is needed, therefore, are techniques for efficiently and accurately predicting or otherwise verifying the most current street address (or other such reported contact information), for individuals and entities.

### SUMMARY OF THE INVENTION

One embodiment of the present invention provides a method for verifying the current mailing address of a particular person or entity. The method includes receiving a request to verify a current mailing address of a target person or entity, where the request specifies target information. The method continues with querying one or more databases of previously reported address information to identify previously reported addresses associated with the specified target information, thereby producing initial target search results. The method continues with displaying the initial target search results for review, the initial target search results including one or more target matches that can be selected for verification, with each target match associated with one or more previously reported addresses. The method further includes querying one or more public utility databases for an address associated with a selected target match included in the initial target search results. In response to identifying a current mailing address associated with the selected target match based on public utility database records, the method continues with displaying the current mailing address with a designation of verified.

In response to none of the displayed initial target search results being acceptable, the may further include allowing for refinement of the specified target information. Note that the method may further include receiving input from a user specifying the selected target match so that the querying of one or more public utility databases can be carried out. Further note that, in response to not identifying a current mailing address based on public utility database records, and in response to there being a next target match of interest, the method may further include receiving input from a user specifying the next target match so that the querying of one or more public utility databases can be repeated for that next target match.

The target information may include, for example, at least one of target name information, target address information, a target social security number, a target tax ID number, and a target telephone number. The target information may further include age information about the target. In one particular embodiment, the target information only includes a target telephone number (e.g., land line, cellular, satellite). Note that name and previously reported address information associated with the selected target match can be parsed into individual terms for the querying of the one or more public utility databases. Further note that displaying the current mailing address with a designation of verified may further include displaying a complete address history list, with a marker denoting the current mailing address.

The one or more databases of previously reported address information and the one or more public utility databases can be, for example, an aggregated local database. Alternatively, the databases can be distributed and/or remote. The one or more databases of previously reported address information may further include other previously reported target contact information that can be queried, including at least one of target social security numbers, target tax ID numbers, target telephone numbers, target facsimile numbers, and target age information. Likewise, the one or more public utility databases may further include other high-confidence target contact information that can be queried, including at least one of target social security numbers, target tax ID numbers, target telephone numbers, target facsimile numbers, and target age information.

Another embodiment of the present invention provides a method for verifying the current mailing address of a target person or entity. This particular method includes querying one or more databases of previously reported address information to identify previously reported addresses associated with a target, thereby producing initial target search results. The method further includes displaying the initial target search results for review and possible selection for verification. The method proceeds with querying one or more public utility databases for an address associated with a selected target match included in the initial target search results. In response to identifying a current mailing address associated with the selected target match based on public utility database records, the further includes displaying the current mailing address with a designation of verified. Note that the methods described herein can be embodied, for example, as a processor readable medium (e.g., server or disk) containing processor-executable instructions for verifying the current mailing address of a target person or entity in accordance with the described methods. In one such embodiment, the one or more databases of previously reported address information and the one or more public utility databases are an aggregated local database. In another such embodiment, name and previously reported address information associated with the selected target match is parsed into individual terms for the querying of the one or more public utility databases.

Another embodiment of the present invention provides a system for verifying the current mailing address of a target person or entity. The system includes a module for querying one or more databases of previously reported address information to identify previously reported addresses associated with a target, thereby producing initial target search results. The system also includes a module for displaying the initial target search results for review and possible selection for verification. Also included is a module for querying one or more public utility databases for an address associated with a selected target match included in the initial target search results, to identify a current mailing address associated with the selected target match based on public utility database records. The system further includes a module for displaying the current mailing address with a designation of verified. The may further include an aggregated local database that is communicatively coupled to the modules for querying, where the local database includes the one or more databases of previously reported address information and the one or more public utility databases.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 illustrates a block diagram of a system configured to verify the mailing address of a particular individual or entity, in accordance with one embodiment of the present invention.

FIG. 2 illustrates a method by which a user can verify the contact information of a particular individual or entity, in accordance with one embodiment of the present invention.

FIG. 3 illustrates a method by which a user can verify the mailing address of a particular individual or entity, in accordance with one embodiment of the present invention.

FIG. 4a is a graphical user interface for initiating contact information verification for a particular target in accordance with one embodiment of the present invention.

FIG. 4b shows graphical user interfaces displaying initial target search results and selected target match verification results in accordance with one embodiment of the present invention.

FIG. 4c shows graphical user interfaces displaying initial target search results, selected target match verification results, and a current address for selected target match in accordance with one embodiment of the present invention.

### DETAILED DESCRIPTION OF THE INVENTION

Embodiments of the present invention provide techniques for verifying contact information (e.g., current mailing address) of a particular individual or business or other entity. The invention can be implemented, for example, as a software system that queries a database to match previously reported addresses against public utility records. The queried database can be, for instance, a local database that is aggregated from one or more publicly available historical address sources (e.g., online yellow or white pages databases), as well as one or more public utility databases (or other high-confidence databases). Alternatively, the queried database can be left in a distributed form (as opposed to an aggregated form), where a number of remote databases (e.g., a publicly available historical address database and a public utility database) that exist independently at various locations are queried individually.

In one particular embodiment, an initial query/search on a “target” (e.g., person or business) is performed to identify previously reported addresses of that target. This initial query can be initiated by a user (e.g., paying customer), and includes information that is known about the target, such as the target's name, along with the city and/or state in which the target is to believed to reside. The initial query attempts to match the specified target information to existing entries in a database storing previously reported addresses. Any matches resulting from this initial target search are presented to the user. The user then can either re-query if no acceptable target match has occurred, or select a target match for verification.

Target matches selected for verification will contain one or more previously reported addresses associated with the target match. Each of these previously reported addresses are then queried into a database storing public utility records. Public utility records include high-confidence contact information, as utilities are typically the first services engaged at a new home or business location. Example public utilities include cable, electric, gas, telephone, sewer, and water. Other such high confidence contact information sources will be apparent in light of this disclosure. If a previously reported address associated with a selected target match is verified based on the public utility records, then that address (or other contact information) is reported to the user. The verified address can be distinguished from other previously reported addresses with a marker or other designation to let the user know that there is a high degree of confidence that the marked address is the current mailing address of the specified target.

Such high-confidence contact information is valuable for numerous applications. For example, the postal service and other similar delivery businesses can utilize the present invention to verify target/address combinations contained within their respective databases. Likewise, an attorney that needs to serve process papers or class action documents requires accurate target/address combinations for attempted service or risks dismissal of a lawsuit. Law enforcement personnel require accurate target/address combinations or risk entry into an innocent person's home. Reliable target/address combinations are also important for successful targeted mailing and marketing campaigns, as well as in tracking suspected terrorists, illegal aliens, debtors, and other persons that might need to be contacted or monitored.

It is noted that some applications will be entitled to greater access to high-confidence databases than other applications. For example, applications related to national security issues and to protecting the general public may be afforded greater access to public utility records than pure commercial applications such as delivery services. In any case, the present invention is not intended to be limited by such restrictions, and particularly where embodiments of the invention can be carried out should the proper permissions and/or access privileges be in order. Moreover, embodiments of the present invention can be tailored to satisfy or otherwise comply with any legal requirements of the federal and state governments.

System Architecture

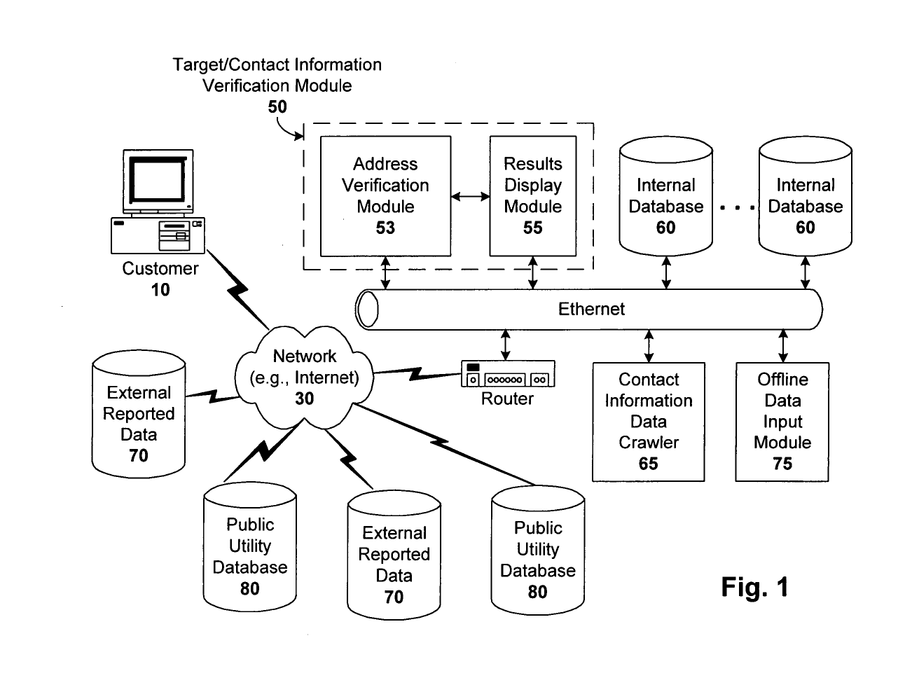

FIG. 1 illustrates a block diagram of a system configured to verify the mailing address of a particular individual or entity, in accordance with one embodiment of the present invention.

The user can log into or otherwise access the system via device 10. The device 10 can be any form of computer such as a cellular/satellite phone, personal computer, laptop, personal digital assistant, or tablet that is connected to the communications network 30 (e.g., Internet) to which the system is coupled. The network 30 and connections thereto can be conventionally implemented with wired or wireless technology, to provide “online” access. Alternatively, the user can access the system “on-site” at, for example, a library or government facility (e.g., post office or FBI). In such an embodiment, the system (including device 10) could be integrated into a conventional wired or wireless local area network. Alternatively, the user can call into customer service (not shown) to indirectly access the system through the use of a customer service representative or a menu guided telephone interface.

The user may be, for example, an online customer looking to track down an old friend or colleague. Alternatively, the user may be a service provider (e.g., USPS or other delivery service, lending institution, lawyer) wishing to verify that reported contact information for various individuals/entities is accurate and/or to get current contact information. Alternatively, the user may be a government agency (e.g., police, INS, FBI) wishing to track or monitor the movement of various individuals suspected of terrorism or other malfeasance. Alternatively, the user may be a cellular customer looking to identify an unknown caller associated with an incoming call. In this case, the user could wirelessly access the system, for example, via an overhead channel or other secondary communication link so that the number of the incoming call could be matched with a particular caller.

As can be seen, the system includes a target/contact information verification module 50 that is communicatively coupled with a local database 60, a contact information data crawler 65, and an offline data input module 75. Any conventional networking techniques can be used here, with this particular example using an Ethernet architecture. The Ethernet or other local are network architecture is communicatively coupled to the network 30 (e.g., via a router), and a number of remote databases 70 and 80 are connected to the network 30. The user of device 10 can access the system via the network 30 to commission a contact information verification for a particular target. The results are then presented to the user in a report.

In this particular embodiment, the target/contact information verification module 50 includes an address verification module 53 and a results display module 55, and is programmed or otherwise configured to identify with high-confidence the current mailing address of the specified target individual or entity. Using the device 10, the user provides an initial query/search on a person, business, or other target to identify previously reported addresses of that target.

This initial query includes information that is known about the target, such as the target's name, along with the city and/or state in which the target is to believed to reside. Other information that may form a basis for the query includes, for example, zip code, telephone number, social security number/tax ID number, date of birth/approximate age. Any combination of such information can be used in the query, with some information being weighted higher than other information.

For example, in the case where the target is a person, the search query may specify the person's first and last name and the city of the last known address. Such primary information (e.g., medium weight) will allow for a general search of previously reported addresses. Premium target information (e.g., high weight), such as middle name or initial, social security number, and telephone number may also be included to focus the search results. Other target information (e.g., low weight), such as birthday or approximate age or year founded may also be included to increase the precision of the search results.

Generally stated, an initial query including high, medium, and low weight target information is ideal. However, in certain instances, it is possible that only limited information will be known, such as an unknown caller's telephone number (e.g., high weight information only), or a target's name (e.g., medium weight information only). Alternatively, the known information may include, for example, the target's last name and his approximate age (e.g., medium weight information+low weight information=high weight information).

The initial query is provided to the address verification module 53 via the network 30, router, and Ethernet. The address verification module 53 parses the target information in the user's query, and initiates a search of one or more databases. In this particular example, the local/internal databases 60 can be accessed, which are aggregated from external reported data sources 70. The aggregation can be carried out using the contact information data crawler module 65 (e.g., programmed to harvest target contact information from various remote databases into a local database), as well as the offline data input module 75 (e.g., allows for data input by manual data entry and scanning/OCR operations). Note that multiple contact information data crawler modules 65 and/or offline data input modules 75 can be employed, where such modules could run in parallel to efficiently maintain a current local database of contact information. Alternatively, each of the external reported data sources 70 could be searched directly, either one at a time or in parallel.

Further note that the address verification module 53 can execute the initial query in multiple stages. For instance, the primary information provided by the user can be searched first to provide a large pool of possible target matches. Then, a second query including premium target information can be run, to narrow that pool to more likely matches. In any case, the initial query attempts to match the specified target information to existing entries in the databases 60 and/or 70 to identify previously reported addresses of the target. Any matches resulting from this initial target search are returned to the address verification module 53, and then presented to the user using the results display module 55. Generally, the results display module 55 is configured to present the results to the user's display, which could be the display of a PC, laptop, PDA, or cell phone. Note that search results that match or otherwise amount to high weight information can be distinguished for the user's convenience.

For example, the high weight search results can be listed first in the overall display of information to the user. Alternatively, the high weight search results can be bolded. Numerous possible combinations of target information and weighting schemes will be apparent in light of this disclosure. After reviewing the results of the initial query, the user can either re-query if no acceptable target match has occurred, or select a target match for verification.

Target matches selected for verification indicate the name of the target match (e.g., John F. Doe) and one or more previously reported addresses associated with that target match. The address verification module 53 receives the user's selection, and queries each of the previously reported addresses to one or more databases storing public utility records. In this particular example, the local/internal databases 60 can be accessed, which are aggregated from public utility databases 80. As previously explained, the aggregation can be carried out using the contact information data crawler module 65, as well as the offline data input module 75. Note that the internal databases 60 can be stocked with both the previously reported addresses (for the initial query) and public utility records (for the second query). Alternatively, each of the public utility databases 80 could be searched directly, either one at a time or in parallel.

Whether the previously reported address data from databases 70 and the records from the public utility databases 80 are aggregated and stored locally in database 60 or left in their distributed, remote form will depend on a number of factors, including the desired system processing time. Aggregated local database 60 will allow for faster “real-time” processing, which may be desirable for some applications (e.g., cellular phone customer attempting to match an incoming telephone number to a particular individual or entity). However, the present invention is not intended to be limited to local database configurations. Rather, any database scheme, whether local, remote, or some combination thereof, can be employed here.

In any case, the address verification module 53 queries each of the previously reported addresses to one or more databases storing public utility records, which contain high-confidence contact information. Each previously reported address can be parsed into a broadly defined query (e.g., first name, last name, street number, street name, street designee, city, and state). Such a broad query will help mitigate the impact of incorrectly reported address details included in the databases 70. The results of the query are returned to the address verification module 53.

If the address verification module 53 determines that a previously reported address associated with a selected target match is verified based on the public utility records, then that address (and/or other contact information included in the public utility records) is reported to the user using the results display module 55. As previously explained, the verified address can be distinguished from other previously reported addresses with a marker to let the user know that there is a high degree of confidence that the marked address is the current mailing address of the specified target. Other contact information included in the public utility records (e.g., telephone number, years at address) may be presented to the user as well.

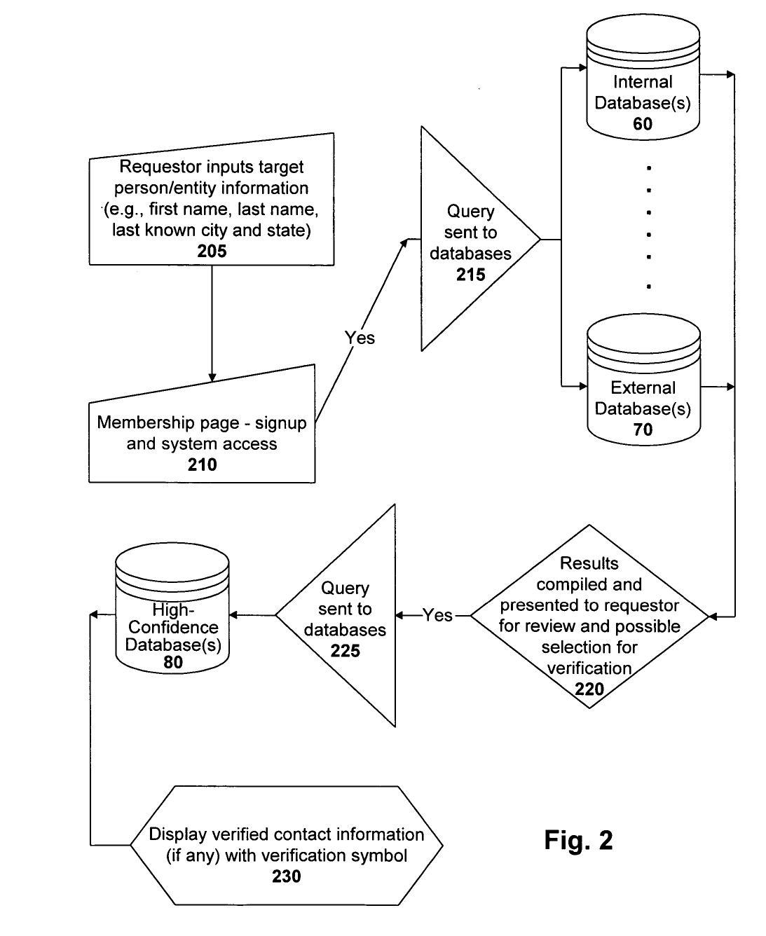

Each functional module of the system can be coded using conventional programming languages and techniques, such as C, C++, or Visual Basic, and executed in a conventional processing environment (e.g., microprocessor or microcontroller unit). Also, Extensible Markup Language (XML) and other suitable mark-up languages can be used for creating Web documents for an Internet-based system. In one particular embodiment, the system employs XML to retrieve information matching the user's input/query, and to return output that is posted to a report that is viewable by the user. In addition, the system can use ColdFusion Markup Language (CFML) to execute the XML gateways with existing databases and parse the output accordingly. The target information that can be queried via XML include, for example: the target individual's or entity's name; last known city, state and zip; telephone number; social security or tax ID number; and approximate age. Example functionality of the modules will be discussed in detail with reference to FIGS. 2-4c.

Methodology

FIG. 2 illustrates a method by which a user can verify the contact information of a particular individual or entity, in accordance with one embodiment of the present invention. As explained in reference to FIG. 1, the user can use a computer or other communications device (e.g., cellular phone or workstation on a network) to establish a connection with a system that carries out the method. The access process can be implemented with conventional techniques as previously discussed. The method can be employed by any service provider or agency, such as the USPS, a police or security agency, a credit issuer, or an online directory or “people search” service. There can be a subscription fee or a user fee applicable.

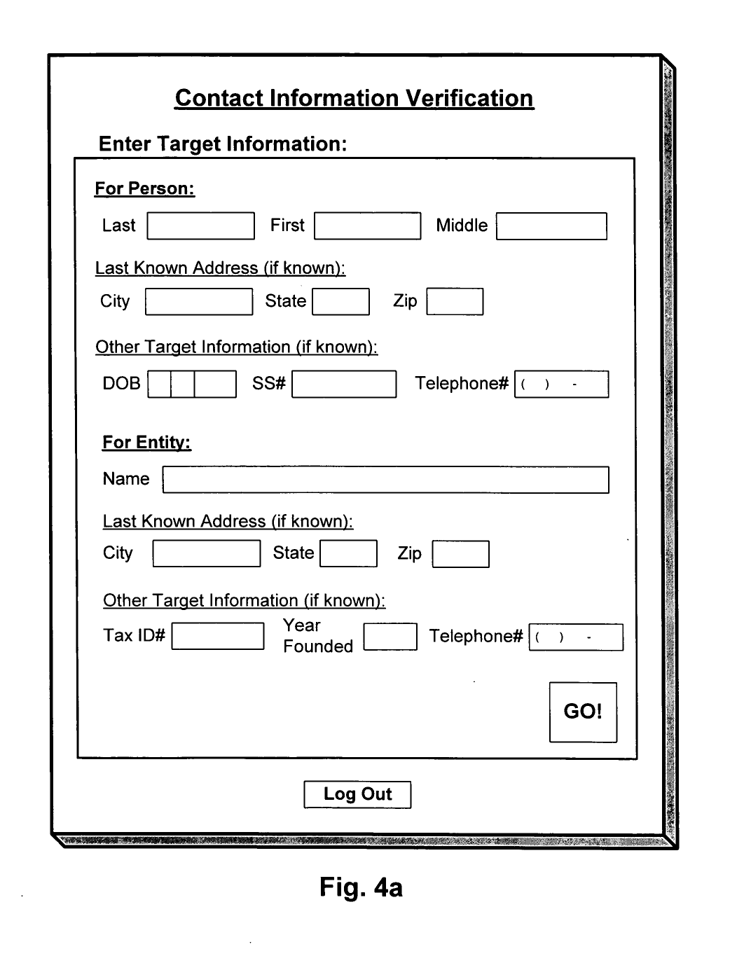

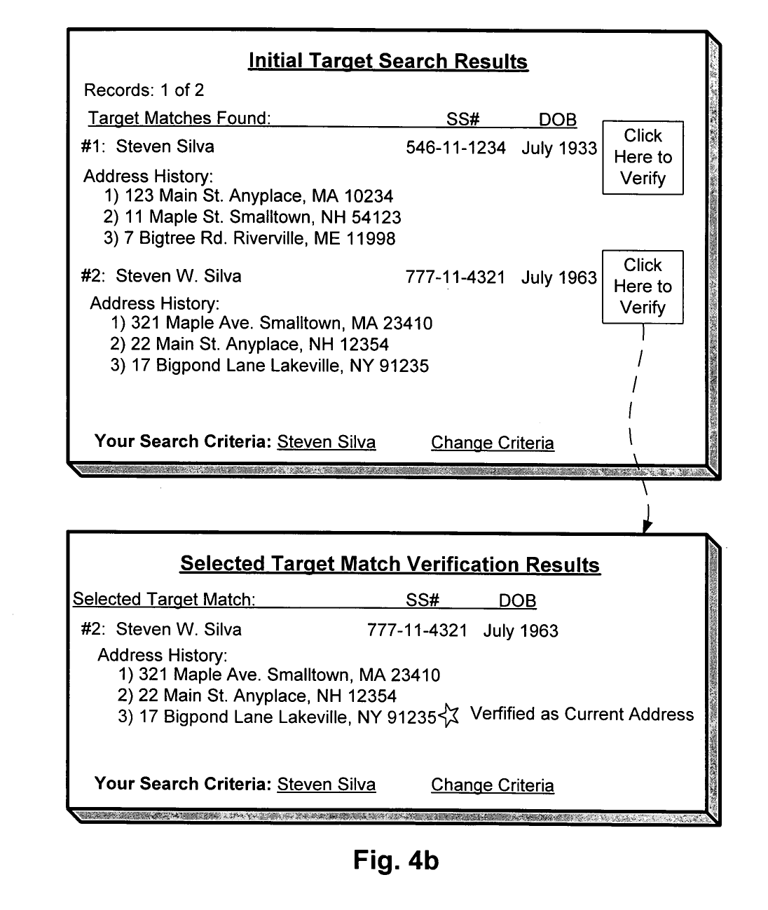

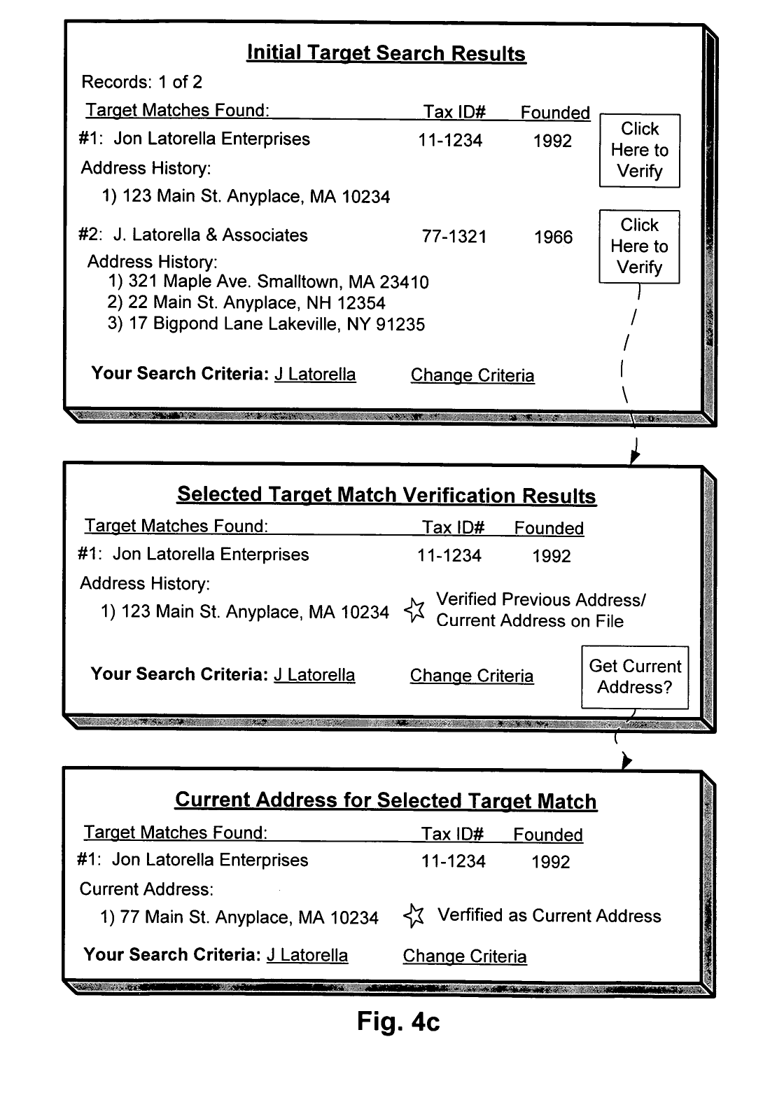

The method begins with the user or “requester” inputting 205 or otherwise providing target person or target entity information, such as first, middle, and last name, last known city and state of residence, telephone number, social security number, date of birth or approximate age. FIG. 4a is an example graphical user interface that can be used in capturing the target information. Recall that not all listed information is required, and various combinations of information can be used (e.g., name and last known city; name only; telephone number only; social security number only; first and last name and city and state and approximate age).

As previously stated, the user can be, for example, a postal or shipping clerk, a detective or investigator, a repo-man, or an attorney looking to verify addresses so that parties to a legal action can be properly notified. Other user data can be requested as well, depending on the particular application and the type of verification being conducted. Upon providing the target information, the user is presented with a membership page or otherwise guided through the membership/access process by a customer service representative of the verification service.

Here, the method continues with the user signing up for the verification service (assuming the user has not already done so) and/or accessing 210 the verification system. In one particular embodiment, the method here includes having the user input credit card information to pay for the service. The fee for membership can be charged, for example, via a security and payment e-commerce site (e.g., VeriSign). If the individual chooses a payment method, he will need to supply all pertinent information as required for authentication and validation of the Internet e-commerce web site. Alternatively, the user can be billed periodically (e.g., monthly) for the service based on system access and activity.

Upon receiving the user's log on and target information, the method continues with querying 215 one or more databases to search for previously reported contact information associated with the target. In one embodiment, the query performed includes searching a database stocked with publicly available historical address information for addresses associated with the target information specified in the query. As will be apparent in light of this disclosure, numerous other types of contact information (e.g., telephone number, email address) that can be legally accessed can be searched to assist the contact verification process.

Upon completion of the database query, the method continues with compiling 220 the results of the query, and presenting those results to the user for review and possible selection for verification (if so desired). Thus, the user can view the previously reported contact information and the target match associated with that contact information, and can select a target match that the user recognizes as the target of interest for contact information verification. FIGS. 4b and 4c each show example graphical user interfaces displaying initial target search results, where FIG. 4b is directed to a person and 4c is directed to an entity.

If the user selects one of the target matches for verification, the method continues with querying 225 a database of high-confidence contact information. This query attempts to match the previously reported contact information of the selected target match to an entry or record in the high-confidence database. Each entry/record in the high-confidence database provides a “target-contact_information” combination that specifies the likely current contact information for the specified particular target. If a match is found, then the method continues with displaying 230 that previously reported contact information with a verification symbol. Thus, the user can identify with high-confidence the current contact information for the selected target match. FIGS. 4b and 4c each show example graphical user interfaces displaying selected target match verification results, where one reported address associated with the selected target match is designated with a star symbol as being the verified current address.

As previously explained, the databases accessed in steps 215 and 225 may be local (e.g., where one or more local databases are stocked via operation of an aggregator system of targeted data crawlers and/or local data entry techniques), remote (e.g., where each accessed database is stocked independently at various locations), or a combination of local and remote databases. In one particular embodiment, the databases queried in steps 215 and 225 are a local database to facilitate rapid query-based searching. Here, the database would include an aggregation or collection of historical and/or public contact information records (e.g., reported in online white and yellow pages), as well as records of high-confidence combinations of “target-contact_information” (e.g., target name+current address of electric company customers+current cell and/or home telephone number of target).

The database can be structured and organized using conventional techniques to further facilitate rapid searching. For instance, the database(s) may include multiple database subsets, files and records gathered from any number of sources. The multiple sources may specify, for example, multiple addresses (or other contact information) with a possibility of dates ranging from the current year to the prior forty years. Each data subset can be contained within a data field of a database, and the displaying 230 includes presenting a list of the subset lookup results for review by the user, wherein the list of the subset lookup is selected from the result query, and wherein the data subset can be installed and linked against other data.

Note that additional functionality may be included in the method. For instance, the method may further include a manual verification process, wherein an offline search/investigation can be conducted to verify current contact information, particularly where high-confidence online repositories are not available via an external Internet connection.

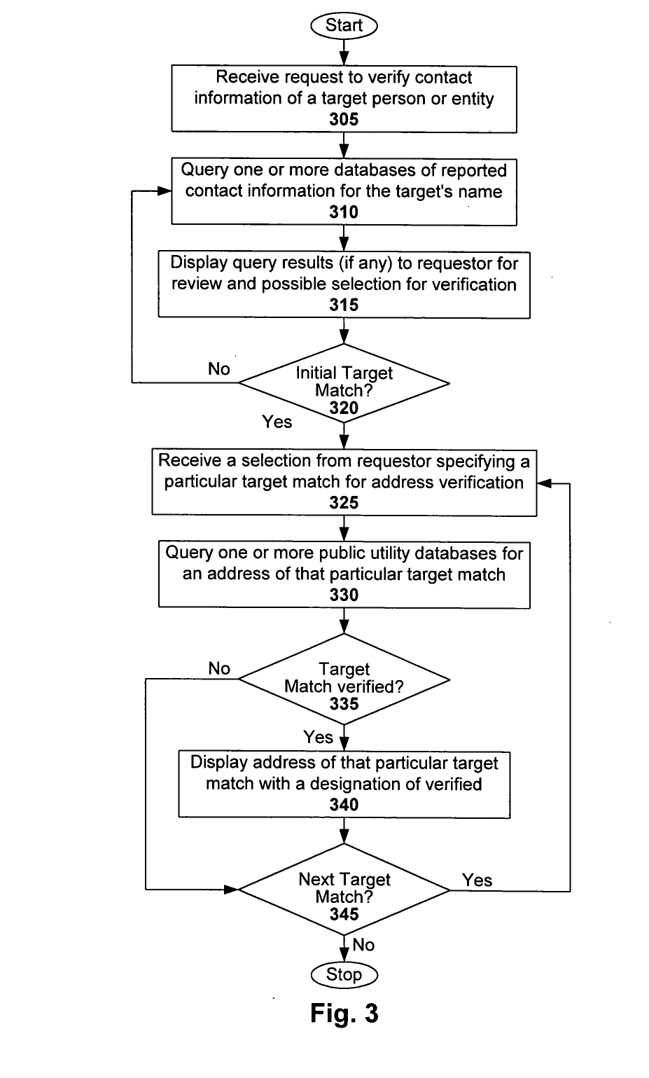

FIG. 3 illustrates a method by which a user can verify the mailing address of a particular individual or entity, in accordance with one embodiment of the present invention. This particular example method can be viewed as a specific embodiment of the method shown in FIG. 2. Thus, relevant discussion in reference to FIG. 2 is equally applicable here.

The method can be carried out, for example, by the target/contact information verification module 50. In one such embodiment, the target/contact information verification module 50 (including the address verification module 53 and the results display module 55) is implemented as a processor readable medium containing processor-executable instructions for performing the address verification method as described herein. Note that functionality of the illustrated modules can be integrated into a single module, or implemented as a number of distinct modules that interact with one another, as will be apparent in light of this disclosure.

The verification method begins with receiving 305 a request to verify contact information of a target person or entity, and in particular, to verify the current mailing address of the specified target. The method continues with querying 310 one or more databases of reported contact information for the target's name. FIG. 4a is an example graphical user interface that can be used in providing the query's target information. As previously stated, an initial query including high, medium, and low weight target information is ideal.

However, in certain instances, it is possible that only limited information will be known, such as the target's telephone number or social security number (e.g., high weight information only), or the target's name and/or last known address (e.g., medium weight information only). Alternatively, the known information may include, for example, the target's last name and approximate age (e.g., medium weight information+low weight information=high weight information).

The method continues with displaying 315 the results of the initial query (if any) to the requestor for review and possible selection for verification. FIGS. 4b and 4c each show example graphical user interfaces displaying these results (“initial target search results”), where FIG. 4b is directed to a person and 4c is directed to an entity. Recall that the search results of the initial query can be presented according to a weight-based priority scheme.

For example, note that in FIG. 4a, the search criteria was “Steven” and “Silva”. Assume that this information (the target's fist and last name) qualify as medium weight target information. Further note that two target matches were returned in response to the query, with each match possessing 100% of the search criteria. Thus, neither match possesses a greater weight than the other, and no particular priority is assigned. However, if the search criteria further included the target's middle initial of “W” (which would qualify as high weighted target information), then target match #2 (“Steven W. Silva”) would have a higher weight than target match #1 (“Steven Silva”). In such a case, target match #2 could be bolded or listed in the target match #1 position. Such weighting, however, is not necessary to practice the present invention.

The method continues with determining 320 whether there is an initial target match, based on input by the requestor. If none of the displayed target matches is acceptable to the requestor, then the method proceeds back to step 310 where the requestor is allowed to refine the search criteria of the query. Alternatively, the requestor can simply terminate the search.

If, however, one of the displayed target matches is acceptable to the requestor, then the method proceeds with receiving 325 a selection from requestor specifying that particular target match of interest for address verification. This selection can be carried out, for example, by clicking the “Click Here to Verify” button associated with that target match, as shown in FIGS. 4b and 4c. Other graphical user interface techniques and the underlying functionality for carrying out this selection can be used here as will be apparent in light of this disclosure.

In response to the requestor's selection, the method continues with querying 330 one or more public utility databases for an address of that particular target match. Recall that records from the one or more public utility databases can be aggregated into a local database, so that querying 330 can be locally performed. In the example shown in FIG. 4b, target match #2 is selected. Thus, each of the three addresses associated with that target match (i.e., 321 Maple Ave. Smalltown, Mass. 23410; 22 Main St. Anyplace, N.H. 12354; and 17 Bigpond Lane Lakeville, N.Y. 91235) are parsed into a broadly defined query. The query for the first address might be, for example: “Steven W, Silva, 321, Maple, Ave, Smalltown, Mass., 23410”, where each piece of information specified in the query is searched. A 100% match would be ideal, but it is possible that less than 100% will result.

For instance, the target's middle initial “W” may not be of record at the public utility database. Likewise, there may be a typo in the parsed information (e.g., zip code should be 02341, not 23410; street designee should be Street, not Ave; and Smalltown should be Small Town). Thus, a number of analysis and weighting schemes can be employed to predict the best possible matches.

Table 1 shows one such scheme, where a percentage match (% Match) is determined based on the ratio of similar characters between a query term and a likely corresponding public utility record term. Note also that alternative representations of search terms can be considered. For instance, a query term of “Massachusetts” could be automatically searched as MA, Massachusetts, and Mass to improve chances of a 100% match with the “MA” in the public utility record. In any case, the calculated % Match is then compared to a threshold (% Match Threshold) to determine if the match is strong enough. In this example, the threshold is set to 70%. Also, each public utility record term is assigned a weight. Thus, if a sufficient term weight is found to satisfy the % Match Threshold, then the queried address can be verified as the current mailing address for the target.

TABLE 1

| | Public Utility | | % Match Threshold | Term |
|---|---|---|---|---|
| Query Term | Record | % Match | Satisfied (e.g., >70%)? | Weight |
| Steven W | Steven | 6/8: 75% | Yes | High |
| Silva | Silva | 5/5: 100% | Yes | High |
| 321 | 321 | 3/3: 100% | Yes | High |
| Maple | Maple | 5/5: 100% | Yes | High |
| Ave | Street | 1/6: 16% | No | Medium |
| Smalltown | Small Town | 9/10: 90% | Yes | Medium |
| MA | MA | 2/2: 100% | Yes | Low |
| 23410 | 02341 | 4/5: 80% | Yes | High |
| (not provided) | 617-777-7777 | N/A | N/A | Very |
| | | | | High |
| (not provided) | 123-34-5678 | N/A | N/A | Very |
| | | | | High |

Sufficient term weight can be based, for example, on a set of pre-established term weight relationships as shown in Table 2:

TABLE 2

| Very High | High | Medium | Low | |
|---|---|---|---|---|
| Weight Terms | Weight Terms | Weight Terms | Weight Terms | Verified? |
| N/A | 4/4: 100% | 1/2: 50% | 1/1: 100% | Yes |
| N/A | 3/4: 75% | 2/2: 100% | 1/1: 100% | Yes |
| N/A | 2/4: 100% | N/A | N/A | No |
| N/A | 2/4: 100% | N/A | N/A | No |
| 1/1: 100% | N/A | N/A | N/A | Yes |
| 2/2: 100% | N/A | N/A | N/A | Yes |

In this example, so long as 100% of the low and high weight terms satisfy the % Match Threshold, then only 50% of the medium weight terms need to match. Also, so long as 100% of the low and medium weight terms satisfy the % Match Threshold, then only 75% of the high weight terms need to match.

Further note from Table 1 that the target's telephone number and social security number were not provided by the requester. Thus, the corresponding entries in the public utility record can be ignored. However, such information is assigned the highest weight (“very high”) in this particular weighting scheme. As indicated in Table 2, a 100% match of such high weight target information to an entry in the public utility record is generally sufficient basis to verify the target match.

Thus, if the requestor's initial query of step 310 only specified the telephone number of “617-777-7777”, then various target matches that were historically and/or currently associated with that telephone number would be presented to the requestor in step 315. After querying the public utility records in step 330, the target match currently associated with that telephone number would be verified (assuming the requestor would select the target match for verification in step 325) and presented to the requestor in step 340. For example, the requester could be presented with: “Steven Silva, 321 Maple Street Small Town, Mass. 02341.”

Various other analysis and weighting schemes can be used here as will be apparent in light of this disclosure. Note, however, that such schemes are used to mitigate problems associated with data errors and omissions, and are not necessary to practice the present invention.

In any event, the method continues with determining 335 if the selected initial target match was verified. If so, then the method continues with displaying 340 the address of that particular target match with a designation of verified. In FIGS. 4b and 4c, for example, the verified address is displayed and designated with a star icon. Note that the requester can be presented with a complete address history list for reporting purposes, with the star icon (or other marker) clearly denoting the verified current address. Further note that FIG. 4c shows an example graphical user interface displaying selected target match verification results that indicate the queried address is actually a verified previous address, and that a current address is available for the target. In this particular case, the target business moved from 123 Main Street to 77 Main Street. This example assumes that the public utility database maintains records of both a previous address and a current address. Thus, not only is the previous address verified, but the user is provided with an opportunity to get the verified current address.

Note that if the selected initial target match is not verified at step 335, then step 340 is skipped. The method continues with determining 345 if there is a next target match. If there is, then the method continues with repeating steps 325 through 345. Otherwise, the method ends.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

1. A method for verifying the current mailing address of a particular person or entity, the method comprising:
receiving a request to verify a current mailing address of a target person or entity, the request specifying target information;
querying one or more databases of previously reported address information to identify previously reported addresses associated with the specified target information, thereby producing initial target search results;
displaying the initial target search results for review, the initial target search results including one or more target matches that can be selected for verification, with each target match associated with one or more previously reported addresses;
querying one or more public utility databases for an address associated with a selected target match included in the initial target search results; and
in response to identifying a current mailing address associated with the selected target match based on public utility database records, displaying the current mailing address with a designation of verified.

2. The method of claim 1 wherein in response to none of the displayed initial target search results being acceptable, allowing for refinement of the specified target information.

3. The method of claim 1 further comprising receiving input from a user specifying the selected target match so that the querying of one or more public utility databases can be carried out.

4. The method of claim 1 wherein in response to not identifying a current mailing address based on public utility database records, and in response to there being a next target match of interest, the method further comprises:
receiving input from a user specifying the next target match so that the querying of one or more public utility databases can be repeated for that next target match.

5. The method of claim 1 wherein the target information includes at least one of target name information, target address information, a target social security number, a target tax ID number, and a target telephone number.

6. The method of claim 5 wherein the target information further includes age information about the target.

7. The method of claim 1 wherein the target information includes a target telephone number.

8. The method of claim 1 wherein the one or more databases of previously reported address information and the one or more public utility databases are an aggregated local database.

9. The method of claim 1 wherein name and previously reported address information associated with the selected target match is parsed into individual terms for the querying of the one or more public utility databases.

10. The method of claim 1 wherein displaying the current mailing address with a designation of verified further includes displaying a complete address history list, with a marker denoting the current mailing address.

11. The method of claim 1 wherein the one or more databases of previously reported address information further include other previously reported target contact information that can be queried, including at least one of target social security numbers, target tax ID numbers, target telephone numbers, target facsimile numbers, and target age information.

12. The method of claim 1 wherein the one or more public utility databases further include other high-confidence target contact information that can be queried, including at least one of target social security numbers, target tax ID numbers, target telephone numbers, target facsimile numbers, and target age information.

13. A method for verifying the current mailing address of a target person or entity, the method comprising:
querying one or more databases of previously reported address information to identify previously reported addresses associated with a target, thereby producing initial target search results;
displaying the initial target search results for review and possible selection for verification;
querying one or more public utility databases for an address associated with a selected target match included in the initial target search results; and
in response to identifying a current mailing address associated with the selected target match based on public utility database records, displaying the current mailing address with a designation of verified.

14. The method of claim 13 wherein the one or more databases of previously reported address information and the one or more public utility databases are an aggregated local database.

15. The method of claim 13 wherein name and previously reported address information associated with the selected target match is parsed into individual terms for the querying of the one or more public utility databases.

16. A processor readable medium containing processor-executable instructions for verifying the current mailing address of a target person or entity, the processor-executable instructions comprising instructions for
querying one or more databases of previously reported address information to identify previously reported addresses associated with a target, thereby producing initial target search results;
displaying the initial target search results for review and possible selection for verification;
querying one or more public utility databases for an address associated with a selected target match included in the initial target search results; and
in response to identifying a current mailing address associated with the selected target match based on public utility database records, displaying the current mailing address with a designation of verified.

17. The processor readable medium of claim 16 wherein the one or more databases of previously reported address information and the one or more public utility databases are an aggregated local database.

18. The processor readable medium of claim 16 wherein name and previously reported address information associated with the selected target match is parsed into individual terms for the querying of the one or more public utility databases.

19. A system for verifying the current mailing address of a target person or entity, the system comprising:
a module for querying one or more databases of previously reported address information to identify previously reported addresses associated with a target, thereby producing initial target search results;
a module for displaying the initial target search results for review and possible selection for verification;
a module for querying one or more public utility databases for an address associated with a selected target match included in the initial target search results, to identify a current mailing address associated with the selected target match based on public utility database records; and
a module for displaying the current mailing address with a designation of verified.

20. The system of claim 19 further comprising an aggregated local database that is communicatively coupled to the modules for querying, the local database including the one or more databases of previously reported address information and the one or more public utility databases.
